(19) United States
(12) Patent Application Publication
(10) Pub. No.: US 2009/0192834 A1
(43) Pub. Date: Jul. 30, 2009

(54) Revenue generation method for monitoring of fluid dispensing system

(76) Inventors: David J. Adams, Midlothian, VA (US); Mark Allen Babb, Midlothian, VA (US)

Correspondence Address: MATTHEW J. ESSERMAN, 1414 S Penn Sq Unit 20F, PHILADELPHIA, PA, 19102, US

(21) Appl. No.: 12/011,366

(22) Filed: Jan. 25, 2008

(51) Int. Cl. G06Q 10/00

(52) U.S. Cl. 705/7

(57) ABSTRACT

A method of generating revenue for monitoring of a fluid dispensing system is provided. The method comprises providing a manually initiated cleaning system that cleans the fluid dispensing system. The cleaning system is manually initiated by a user of the cleaning system in response to the user of the cleaning system or a user of a monitoring system receiving a notification transmitted by the monitoring system. The method also comprises receiving fees on a periodic basis from the user of the monitoring system thereby generating revenue. The generated revenue is dependent on detected various conditions within the fluid dispensing system thereby providing sufficient and ongoing incentive for users to maintain cleaner lines in order to avoid higher monitoring costs resulting in safer fluid consumption. Alternatively, the manually initiated cleaning system may be replaced with an automated cleaning system.

### FIELD OF THE INVENTION

The present invention relates generally to the field of monitoring of fluid dispensing systems, and, more specifically, to revenue generation methods for monitoring of fluid dispensing systems.

### BACKGROUND OF THE INVENTION

Conventional beer dispensing systems include numerous beer lines through which beer is supplied from kegs to taps, which are operable to dispense the beer to drinking containers such as steins, pilsner glasses and frosty mugs. When a tap is opened, beer is dispensed from the system as a pressure is exerted into the associated keg thereby forcing beer out of the keg and into a beer line which is fluidly coupled to the keg by way of a keg coupler. To accomplish this, the couplers of these conventional systems include an input port to accept gas from a pressurized tank. The kegs and the pressurized tanks are typically maintained in walk-in coolers and the beer lines extend from the walk-in coolers to the taps which are located in at least one tap area. A tap area is commonly located within a bar area of a restaurant. Depending on the length of the beer lines between the walk-in cooler and the bar area, a chiller (e.g. of glycol type) may be used to further cool the beer en route from the walk-in cooler to the taps, especially in the case of long runs between the cooler room and the taps.

Monitoring operation of such conventional beer dispensing systems is purely a manual process. As such, bartenders and restaurant managers typically spend countless hours each month performing various maintenance and operating tasks such as, for example, switching between kegs, monitoring beer usage and estimating future demand figures. In addition to standard operating tasks, beer dispensing systems require periodic cleaning. Conventional cleaning approaches involve the use of portable chemical dispense systems. In this regard, a cleaning technician will manually disconnect the beer lines from each individual keg coupler and then apply cleaning chemicals to the beer lines with the taps in the open position such that the chemicals will be distributed through the lines. Thus, a technician is required to disconnect the beer line from each keg in a beer dispensing system being cleaned, which is a daunting task. Because these current approaches require vast amounts of time and effort on the part of the cleaning technicians and because food and health regulations require the cleaning of these fluid dispensing systems on a static and infrequent periodic basis, beer dispensing systems are commonly cleaned on rather lengthy time intervals. Such lengthy cleaning intervals tend to facilitate the collection of bacteria and soil in the beverage lines thereby risking contamination with the beer and potentially making it unsafe for human consumption. Even the slightest contamination that may be acceptable for safety purposes may still be unacceptable to the consumer in terms of negatively affecting taste.

These conventional periodic cleaning approaches (i.e. even when in compliance with the food and health regulations) often generate additional expenses to be adequate in terms of cleaning frequency or efficacy of cleaning processes in situations when, for example, an unexpected increase in contamination has occurred between the static, periodic cleanings imposed by the food and health regulations. However, current monitoring systems employed to monitor fluid dispensing systems do not consider the amount or frequency of cleaning processes required when determining monitoring costs. As a result, monitoring costs often become quite considerable in situations where relatively higher cleaning processes or an increase in cleaning frequency need to be performed. For example, relatively higher contaminated fluid dispensing systems require additional monitoring expenses related to generation, transmission, and logging of additional alerts to be sent to cleaning personnel. These additional monitoring services tend to require additional resources such as hardware, manpower, electricity, etc. to fulfill the desired level/frequency of monitoring/cleaning required. These additional monitoring services lead to increased and unrealized costs for the provider of the monitoring system. Thus, the provider of the monitoring system has not accounted for nor been able to recoup these additional expenses which may substantially affect profitability for the provider of the monitoring system. Therefore a need arises that would fairly compensate the provider of the monitoring system for the additional expenses involved with correspondingly higher monitoring costs. Correspondingly, decreased expenses have also not been accounted for by the provider of the monitoring system in relatively lower contaminated fluid dispensing systems.

It is therefore desirable to provide a method of generating revenue for monitoring of a fluid dispensing system, and that does not suffer from the above drawbacks.

These and other advantages of the present invention will become more fully apparent from the detailed description of the invention hereinbelow.

### SUMMARY OF THE INVENTION

The present invention is directed to a method of generating revenue for monitoring of a fluid dispensing system is provided. The method comprises providing a manually initiated cleaning system that cleans the fluid dispensing system. The cleaning system is manually initiated by a user of the cleaning system in response to the user of the cleaning system or a user of a monitoring system receiving a notification transmitted by the monitoring system. The method also comprises receiving fees on a periodic basis from the user of the monitoring system thereby generating revenue. The generated revenue is dependent on detected various conditions within the fluid dispensing system thereby providing sufficient and ongoing incentive for users to maintain cleaner lines in order to avoid higher monitoring costs resulting in safer fluid consumption. Alternatively, the manually initiated cleaning system may be replaced with an automated cleaning system.

### BRIEF DESCRIPTION OF THE DRAWINGS

For the present invention to be clearly understood and readily practiced, the present invention will be described in conjunction with the following figures, wherein:

FIG. 1 is a schematic view of components utilized in a method of generating revenue for monitoring of an exemplary fluid dispensing system having an exemplary integrated cleaning system, in accordance with a preferred embodiment of the present invention.

FIG. 2 is a view illustrating an exemplary gas-fluid junction, an exemplary coupling, and an exemplary connection therebetween for use in the fluid dispensing system shown in FIG. 1, in accordance with a preferred embodiment of the present invention.

FIG. 3 is a block diagrammatical view of an exemplary detection system for the fluid dispensing system shown in FIG. 1 including a plurality of sensors, in accordance with a preferred embodiment of the present invention.

FIG. 4 is a schematic view of the components shown in FIG. 1 including the plurality of sensors shown in FIG. 3, in accordance with a preferred embodiment of the present invention.

FIG. 5 is a flow chart illustrating operational characteristics for monitoring operation of a fluid dispensing system, in accordance with a preferred embodiment of the present invention.

FIG. 6 is a flow chart illustrating operational characteristics for monitoring pressure readings associated with the fluid dispensing system shown in FIG. 1, in accordance with a preferred embodiment of the present invention.

FIG. 7 is a flow chart illustrating operational characteristics for monitoring temperature readings associated with the fluid dispensing system shown in FIG. 1, in accordance with a preferred embodiment of the present invention.

FIG. 8 is a flow chart illustrating operational characteristics for monitoring gas level readings associated with the fluid dispensing system shown in FIG. 1, in accordance with a preferred embodiment of the present invention.

FIG. 9 is a flow chart illustrating operational characteristics for troubleshooting the fluid dispensing system shown in FIG. 1 in response to detection of a malfunction in the fluid dispensing system, in accordance with a preferred embodiment of the present invention.

FIG. 10 is a block diagrammatical view illustrating a general-purpose computer that may be configured to implement logical operations, in accordance with a preferred embodiment of the present invention.

FIG. 11 is a flow chart illustrating operational characteristics of a method of generating revenue for monitoring of a fluid dispensing system, in accordance with a preferred embodiment of the present invention.

### DETAILED DESCRIPTION OF THE PREFERRED EMBODIMENTS

It is to be understood that the figures and descriptions of the present invention may have been simplified to illustrate elements that are relevant for a clear understanding of the present invention, while eliminating, for purposes of clarity, other elements found in a typical fluid dispensing system or monitoring system for a fluid dispensing system. Those of ordinary skill in the art will recognize that other elements may be desirable and/or required in order to implement the present invention. However, because such elements are well known in the art, and because they do not facilitate a better understanding of the present invention, a discussion of such elements is not provided herein. It is also to be understood that the drawings included herewith only provide diagrammatic representations of the presently preferred structures of the present invention and that structures falling within the scope of the present invention may include structures different than those shown in the drawings. Reference will now be made to the drawings wherein like structures are provided with like reference designations.

For purposes of this disclosure, the term “malfunction(ing)” is hereby defined to include, but not be limited to, requiring servicing, e.g. requiring cleaning, temperature adjustment, pressure adjustment, etc.

The present invention utilizes a system similar to, for example, the type disclosed in U.S. Patent Application Publication US 2006/0113322 by Maser et al. In describing such an exemplary system below and in the accompanying figures, some details may have been omitted for purposes of clarity. However, such omitted details are to be considered conventional and thus are deemed to be within the ordinary knowledge of the skilled artisan within the relevant art.

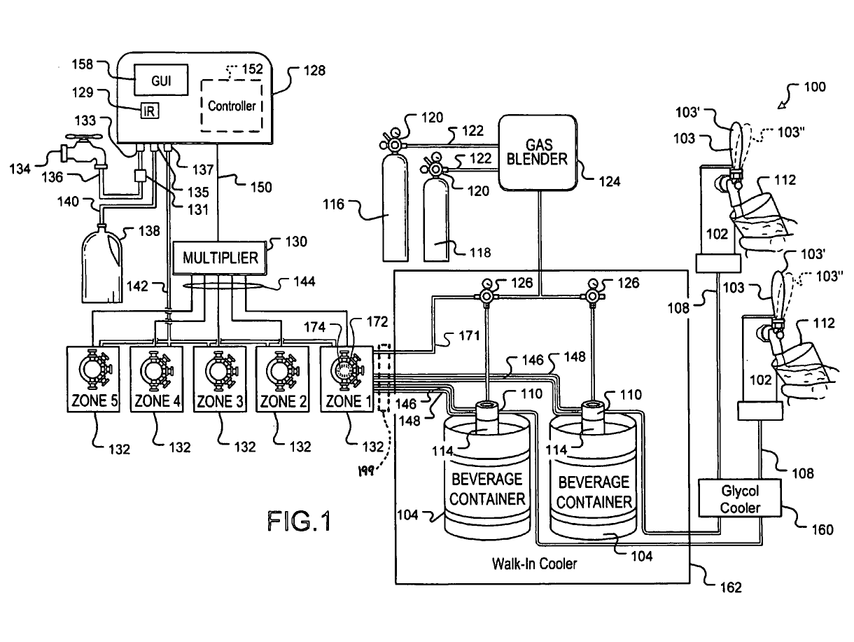

The present invention is generally directed to monitoring operation of a fluid dispensing system, and in accordance with a specific embodiment, a fluid (e.g. beverage) dispensing system (e.g. 100 shown in FIG. 1). In this regard, embodiments of the present invention involve the monitoring of various aspects and parameters of the system operation such as, for example, temperature data, pressure data, gas concentration data, pH data, flow amount data, etc. and/or combinations thereof. Also, in an embodiment, the present invention involves monitoring various operational aspects and parameters pertaining to a chemical dispense system (i.e. an exemplary cleaning system) for cleaning a beverage dispensing system (e.g. 100), as described in U.S. Pat. No. 7,311,224 issued to Emmendoerfer et al. For example, such monitoring may include tracking the times and/or number of instances that a beverage dispensing system (e.g. 100) is cleaned by the chemical dispense system. The chemical dispense system is integrated into the beverage dispensing system (e.g. 100) being monitored, and thus, referred to as an “in-line” cleaning system.

The in-line cleaning system is operable to clean the various beverage-carrying components of a beverage dispensing system (e.g. 100) by applying a cleaning process thereto. Additionally, the in-line cleaning system is also operable to administer beverage conservation and beverage lockout processes in connection with operation of a beverage dispensing system (e.g. 100). In general, the beverage conservation process relates to conservation of a beverage within the fluid lines of a beverage dispensing system (e.g. 100) after the system has been shut off, i.e., inoperable to draw beverage from a beverage source. The beverage lockout process relates to a process for locking a beverage dispensing system (e.g. 100) such that unauthorized use of the system (e.g. 100) is precluded. While the in-line cleaning system accommodates for beverage conservation and lockout, these processes, though not technically cleaning operations, are described for nomenclature purposes as being “phases” of a “cleaning process” administered by the in-line cleaning system in combination with a cleaning phase in which the beverage carrying components of a beverage dispensing system 100 are actually cleaned. Each of these phases of the cleaning process are described in great detail in U.S. Pat. No. 7,311,224 referenced above.

With the above-described environment in mind, FIG. 1 shows a beverage dispensing system 100 having an in-line cleaning system in accordance with an embodiment of the present invention. While many different types of beverages and beverage dispensing systems are contemplated within the scope of the present invention, the beverage dispensing system 100 is described as being a beer dispensing system used to dispense beer to a bar or tap area of, for example, a restaurant or stadium venue. Indeed, those of skill in the art will appreciate that the beverage dispensing system 100 is operable to dispense any other type of beverage, such as, for example, liquor, soda, juice, coffee, water, and dairy products (e.g. milk). Even further, the beverage dispensing system 100 may be utilized to dispense fluids other than beverages such as, for example, paint, oil, lubricant, etc. A combination of any of these above-mentioned fluids may also be dispensed via the fluid dispensing system.

The beverage dispensing system 100 dispenses different labels of beer through individual dispensing units 102, as shown in FIG. 1 in the form of conventional beer taps. The dispensing units 102 include handles 103 that may be toggled manually between an “off” position 103′ and an “on” position 103″, which is shown using dashed lines. Alternatively, the position of the handles 103 may be controlled electronically or pneumatically. Non-handle type switches may alternatively be envisioned. Regardless of the implementation, while the handles 103 are in the “off” position 103′, the dispensing units 102 preclude the flow of beer therefrom. Conversely, while the handles 103 are in the “on” position 103″, the dispensing units 102 enable the flow of beer therefrom and preferably to some form of drinking article, such as a stein, pitcher, glass, cup, or mug 112. To illustrate embodiments of the present invention, the dispensing units 102 are shown in FIG. 1 with the handles 103 in the “on” position 103″.

Prior to being dispensed, the various labels of beer, which are hereinafter referred to generally as beverages, are contained in beverage containers 104. The beverage containers 104 are illustrated in FIG. 1 as being conventional-sized kegs in accordance with an embodiment of the present invention. However, any other type, shape, and size of beverage container from which a beverage may be supplied will suffice. Whereas the dispensing units 102 are preferably located in the bar area, the beverage containers 104 are preferably stored in a distant cooling room, such as walk-in cooler 162, in order to direct and maintain the temperature of the beverages at a desired temperature.

Each dispensing unit 102 is fluidly connected to a beverage container 104 by a beverage line 108. As known to those skilled in the art of beverage dispensing, an optional glycol chiller 160 (or alternatively, an air cooling system or other type of conventional cooling system) may be used to further chill beverages transported between the beverage containers 104 and the dispensing units 102. Furthermore, an optional beverage pump (not shown) may be provided within the beverage line 108 to assist in providing the beverage to the associated dispensing unit 102. Such an implementation is preferable when the distance between the beverage dispenser 104 and the dispensing unit 102 is a relatively great distance. The beverage pump is activated while the handle 103 of the associated dispensing unit 102 is in the “on” position 103″. Conversely, when the handle 103 of the associated dispensing unit 102 is in the “off” position 103′, the beverage pump is de-activated.

As shown in FIG. 1, there exists a 1:1 correlation between dispensing units 102 and beverage containers 104 in accordance with an embodiment of the present invention. Such an implementation is preferred in beer dispensing systems. Alternative embodiments, however, may be configured such that more than one beverage container 104 may provide beverages to a single dispensing unit 102, or vice-versa.

Each beverage line 108 is connected to an associated beverage container 104 by a coupler 110. The couplers 110 are affixed to beverage ports 114 on the associated beverage containers 104 through which the beverages are output for direction by the couplers 110 to the associated beverage lines 108. Each coupler 110 provides functionality for opening the beverage port 114 to which the coupler 110 is affixed and introducing a pressure into the associated beverage container 104 to force the beverage contained therein through the beverage port 114 and to the associated beverage line 108. The connection provided by the coupler 110 between the beverage port 114 and the beverage line 108 is preferably air tight, and thereby operable to force the beverage through the associated beverage line 108 and to the associated dispensing unit 102. Depending on the position of the dispensing unit 102, dispensing of the beverage from the dispensing unit 102 is either precluded (i.e., handle 103 in “off” position 103′) or enabled (i.e., handle 103 in “on” position 103″).

The pressure used to force beverages from the beverage containers 104 to the dispensing units 102 via the beverage lines 108 is supplied to the couplers 110 from one or more pressure sources (e.g. 116 and 118). These pressure sources 116, 118 are shown in accordance with an embodiment as being compressed gas tanks having different reference numerals (i.e., 116 and 118) to differentiate between the different types of gas contained by each. For example, pressure source 116 includes carbon dioxide and pressure source 118 includes nitrogen in accordance with an exemplary embodiment.

Each gas tank 116 and 118 includes a primary regulator 120. The primary regulators 120 regulate the flow of gas from the gas tanks 116, 118 to a gas blender 124 via gas lines 122. The gas blender 124 blends the gases from the gas tanks 116 and 118 and provides a mixed gas compound to secondary regulators 126. Each of the secondary regulators 126 regulate the flow of the mixed gas compound from the gas blender 124 to individual couplers 110, thereby providing the requisite pressure to force the beverages from the beverage containers 104 to the dispensing units 102. As such, there preferably exists a 1:1 correlation between secondary regulators 126 and beverage containers 104. In accordance with alternative embodiments, a single secondary regulator 126 may regulate the flow of the mixed gas compound to more than one beverage container 104.

As described above in accordance with an embodiment of the present invention, the beverage dispensing system 100 includes an in-line cleaning system that administers a cleaning process applied to the beverage dispensing system 100. The in-line cleaning system encompasses various components of the beverage dispensing system 100 such as, without limitation, the couplers 110, as well as a chemical control system 128, a multiplier 130 (optional), various data communications lines (e.g. 150 and 144), various substance communication lines (e.g. 146 and 148) and gas-fluid junctions 132, each of which are shown generally in block diagram form in FIG. 1.

The control system 128 is a controller-based system that manages the overall administration of cleaning processes applied to the beverage dispensing system 100. In this regard, the control system 128 includes a controller 152 (preferably internal to the control box 128) that controls and monitors various tasks administered by the control system 128 in performance of cleaning processes. In accordance with an embodiment, the controller 152 is a PLC (programmable logic controller) providing hardened I/O (inputs/outputs) for the control system 128.

The control system 128 also includes one or more display devices or modules, such as, without limitation, a graphical user interface (GUI) 158. The GUI 158 allows a user to monitor and control operation of the control system 128 through a, for example, touch screen interface. For instance, the GUI 158 may present icons to a user that represent the different phases of operation of the cleaning process, including warnings and instructions associated with same. Furthermore, the GUI 158 may present to the user a selection screen that enables the user to control aspects of the cleaning process by defining or modifying the phases of the cleaning process (e.g. whether the cleaning process is to have a cleaning phase, a conservation phase and/or a lockout phase) or the amount of time that each phase is to be administered. In addition, the GUI 158 may function as a security mechanism for limiting access to the control system 128 to authorized users.

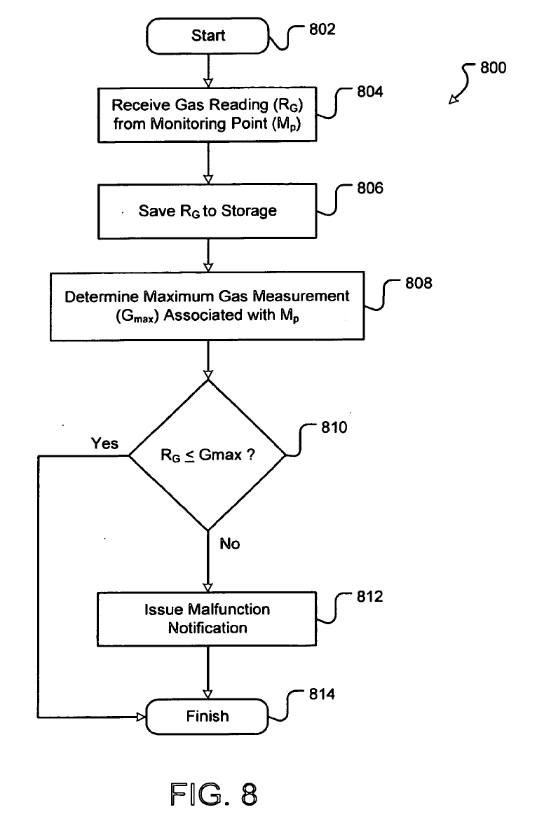

Alternatively, users may interact with the controller 152 by way of an external computer source, such as a handheld device (e.g. a PDA), which may be wireless or wire-based. To effectuate the wireless handheld devices, the control system 128 includes an infrared (or other wireless transmission scheme such as, for example, RF) port 129 for communicating data to and from these devices. In yet another embodiment, the control system also includes a manual switching mechanism (not shown) for use in activating/initiating cleaning processes in desired zones, as described in greater detail with reference to FIG. 8 of U.S. Pat. No. 7,311,224 referenced above.

The multiplier 130 is a stand-alone component of the in-line cleaning system that works in combination with the GUI 158 or other data input means (e.g. external computer or switching mechanism) to activate the cleaning process in certain zones. As such, the multiplier 130 accepts user input from a source requesting the administration of one or more phases of the cleaning process to a zone and activates the phase(s) in that zone. The multiplier 130 is either an integrated circuit (IC) operable to receive and transmit signals for purposes of selecting the gas-fluid junctions 132 for activation, as described below, or a controller (e.g. PLC) programmed to receive and transmit data for these same purposes. In an alternative embodiment, the multiplier 130 may be a module integrated with the controller 152, and thus, contained within the housing of the control system 128. Activation of the cleaning system may be manually initiated via the multiplier 130 regardless of the multiplier's location.

The control system 128 is powered by a power source (not shown), which may be any conventional power source known to those skilled in the art. The control system 128 includes a first fluid input port 133 and a second fluid input port 135 through which water and chemical solutions, respectively, are input to the system 128. Water provided to the first fluid input port 133 is supplied by, for example, a potable water source 134 via a water input line 136. In an embodiment, a backflow prevention device 131 is positioned in the water input line 136 in order to preclude chemical solutions and contaminated water used during cleaning processes from backflowing into the potable water source 134.

Chemical solutions provided to the second fluid input port 135 are supplied by a solution container, such as a jug 138, via a solution input line 140. The control system 128 also includes a fluid output port 137 through which the water and chemical solutions are dispensed out of the system 128 by way of a fluid manifold 142. Those skilled in the art will appreciate that the control system 128 includes pumps, regulators, or the like for enabling the flow of water and chemical solution into the system 128 via the water input line 136 and the solution input line 140 and subsequently out of the system 128 via the fluid manifold 142.

Water and one or more chemical solutions are provided by the control system 128 to the gas-fluid junctions 132 by way of the fluid manifold 142. The gas-fluid junctions 132, when activated by the multiplier as described below, distribute water and chemical solutions from the fluid manifold 142 to couplers 110 for distribution through the beverage lines 108, the dispensing units 102 and any other component through which beverages flow. For illustration purposes, the gas-fluid junction 132 of zone 1 is shown as being connected to the beverage containers 104 by junction-coupler fluid lines 146 that carry the water and chemical solutions from this gas-fluid junction 132 to the couplers 110 when the gas-fluid junction 132 is activated.

The in-line cleaning system also includes junction-coupler gas lines 148 that carry a “control” gas from the gas-fluid junctions 132 to the associated couplers 110. Supply of the control gas to the couplers 110 dictates whether the beverage ports 114 on the associated beverage containers 104 are “open” or “closed,” and thus whether beverages are operable to flow from the containers 104 to the dispense units 102. More specifically, application of control gas to the couplers 110 results in the couplers 110 opening the associated beverage ports 114 and, conversely, termination of the supply of control gas to the couplers 110 results in the couplers 110 closing the associated beverage ports 114.

Thus, the operational state of the beverage dispensing system 100 involves the application of control gas to the couplers 110 and, during such application, beverages are operable to flow from the associated beverage containers 104 to the associated beverage lines 108 (depending, of course, on the positioning of the handles 103). Before any chemicals or water are supplied to a zone in the beverage dispensing system 100 for cleaning, supply of control gas to the couplers 110 in that zone is terminated for the duration of the cleaning process. In effect, the non-application of control gas to these couplers 110 disables the flow of beverage from the associated beverage containers 104 to the associated beverage lines 108, at which time, any phase (e.g. beverage conservation, beverage lockout and cleaning) of the cleaning process may commence.

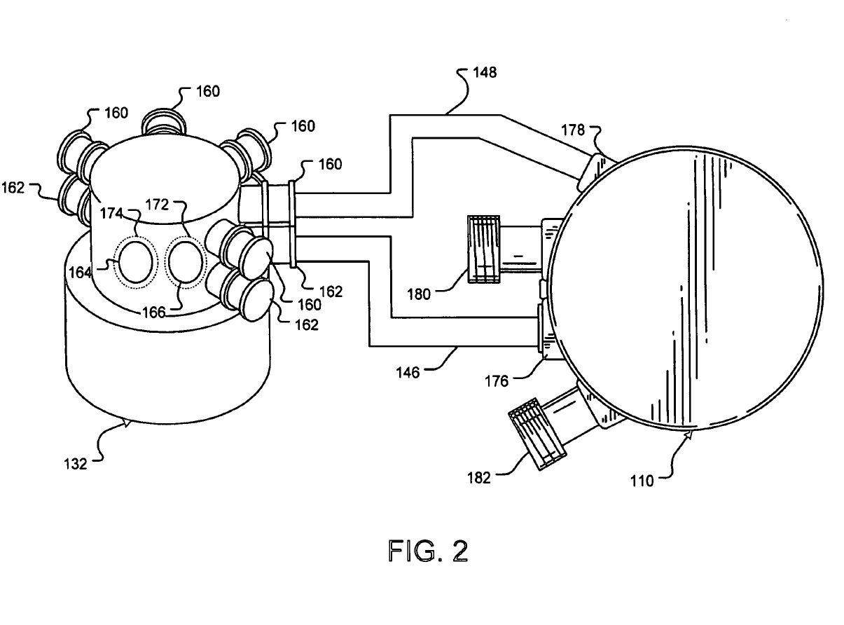

With reference now to FIG. 2, the gas-fluid junctions 132 each include a fluid input port 164 and a gas input port 166. The fluid input port 164 is fluidly coupled to the fluid manifold 142 and thus accepts fluids (e.g. water and chemical solution) therefrom. In an embodiment, the gas input port 166 is coupled to the gas blender 124 by way of a control gas line 171. Alternatively, the gas input port 166 may be coupled directly to either gas tank 116 or 118 without going through the gas blender 124. The gas-fluid junctions 132 also include a plurality of gas output ports 160 and a plurality of fluid output ports 162. Preferably, each of the plurality of gas output ports 160 are paired with one of the plurality of fluid output ports 162.

A gas control valve 172, generally represented using dashed lines, is situated internal to each gas-fluid junction 132 and provides functionality for the gas-fluid junctions 132 to accept and reject gas from the gas blender 124. In this regard, the gas control valve 172 fluidly connects the gas input port 166 to the plurality of gas output ports 160 such that gas from the blender 124 is operable to flow therebetween. Each of the gas output ports 160 is coupled to a gas input port 178 on a coupler 110 via a junction-coupler gas line 148 such that gas may flow therebetween. The communication of gas between the output ports 160 on a gas-fluid junction 132 and the gas input ports 178 on the couplers 110 served by that gas-fluid junction 132 operates to maintain the “open” state of the beverage ports 114 on the associated beverage containers 104, as described above. Conversely, terminating supply of gas between the output ports 160 and the gas input ports 178 causes the couplers 110 to bleed the gas in the attached containers 104 to atmospheric pressure thereby closing the associated beverage ports 114. By effectively providing such control, this gas is appropriately referred to throughout this description as “control gas.”

A fluid control valve 174, also generally represented using dashed lines, is situated internal to each gas-fluid junction 132 and provides functionality for the gas-fluid junctions 132 to accept and reject water and chemical solutions from the control system 128. Thus, with similar reference to the gas control valve 172, the fluid control valve 174 fluidly connects the fluid input port 164 to the plurality of fluid output ports 162 such that water and chemical solutions are operable to flow therebetween. Each fluid output port 162 is coupled to a fluid input port 176 on a coupler 110 via a junction-coupler fluid line 146 such that the water and chemical solutions may flow therebetween.

The gas control valve 172 and the fluid control valve 174 are controlled by the multiplier 130 via a low voltage line 144 input to the gas-fluid junction 132 from the multiplier 130. In normal state, i.e., when the beverage dispensing system 100 is in a beverage dispensing mode, the multiplier 130 does not issue a current to any of the gas-fluid junctions 132. In response to direction from the control system 128 to apply one or more phases of the cleaning process to a specific zone, the multiplier 130 issues a current to the gas-fluid junction 132 served by the specified zone thereby “activating” that gas-fluid junction 132. In response to receiving a current over a low voltage line 144, the gas control valve 172 of the activated gas-fluid junction 132 closes, thereby rejecting gas from the gas blender 124. Consequently, the supply of control gas to the couplers 110 served by the activated gas-fluid junction 132 is terminated thereby causing the couplers 10 to vent the content of gas in the associated containers 104, which, in turn closes the beverage port 114 on those beverage containers 104. Substantially concurrently, the issued current opens the fluid control valve 174 to enable the communication of water and chemical solutions to the associated couplers 110 during the requested phase(s) of the cleaning process.

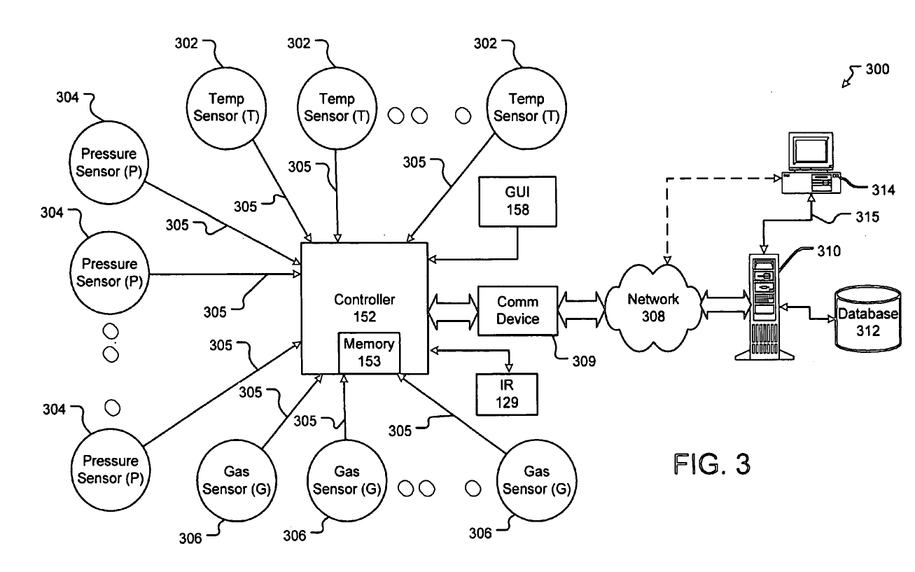

With the general environment in which embodiments of the present invention are applicable provided above, FIG. 3 depicts, in block diagram form, a system for monitoring (hereinafter, “monitoring system”) the beverage dispensing system 100 of FIG. 1 in accordance with an embodiment of the present invention. The monitoring system 300 includes a plurality of sensors, including, without limitation, temperature sensors 302, pressure sensors 304 and gas level sensors 306, each of which are communicatively connected to the controller 152 by way of data communication connections 305. In an embodiment, the data communication connections 305 are wire-based communication media operable to carry a current indicative of sensed information from the sensors 302, 304 and 306 to the controller 152. The data communication connections 305 may additionally or alternatively embody wireless communication technology. It should be appreciated that the manner of implementation of the data communication connections 305 is a matter of choice and the present invention is not limited to one or the other, but rather, either wireless or wire-based technology may be employed alone or in combination with the other.

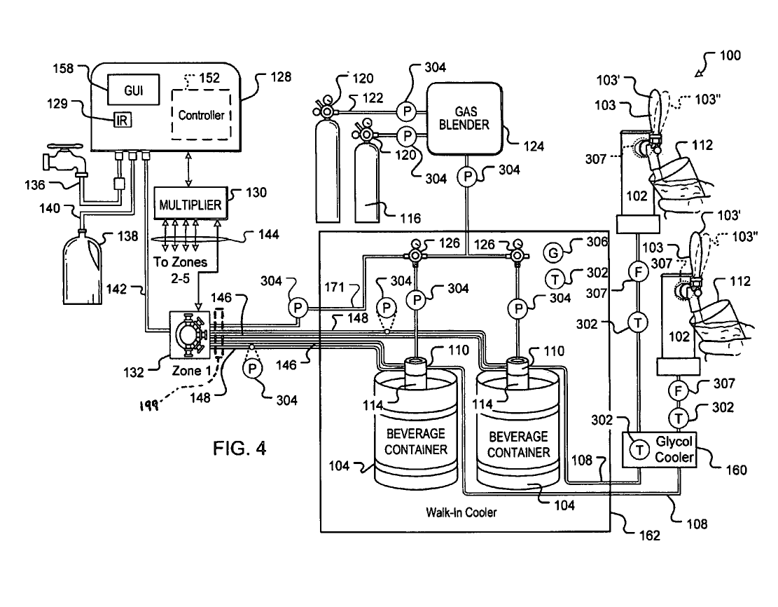

As shown in connection with FIG. 4, the various sensors 302, 304 and 306 are dispersed across different locations (referred to herein as “monitoring points”) of the beverage dispensing system 100. For example, an embodiment of the invention involves the placement of one or more of the following sensors (e.g. 302, 304 and/or 306) at the following exemplary monitoring points in the beverage dispensing system 100: (1) temperature sensors 302: at least one temperature sensor 302 positioned in or adjacent to the walk-in cooler 162 to measure the temperature therein, at least one temperature sensor 302 positioned in or adjacent to each beverage line 108 in order to measure the temperature of beverages flowing through the lines 108 and at least one temperature sensor 302 positioned in or adjacent to the glycol cooler 160 to measure the temperature of beverages output from the glycol cooler 160; (2) pressure sensors 304: at least one pressure sensor 304 positioned in or adjacent to each of the gas lines (e.g. 148, 122, 171) in the system 100 to measure the pressure exerted therein; and (3) gas level sensors 306: at least one gas level sensor 306 in enclosed areas (e.g. walk-in cooler 162) in which gas pressures originate or are regulated.

It should be appreciated that the temperature (302), pressure (304) and gas (306) sensors are shown at the aforementioned monitoring points for illustration purposes only and may be located at any other monitoring points within the beverage dispensing system 100 without departing from the scope of the present invention. Also, those of ordinary skill in the art will appreciate that the sensors 302, 304 and 306 are communicatively coupled to the controller 152 by data communication connections 305, as generally shown in FIG. 3 but not shown in FIG. 4 to avoid cluttering this latter figure.

With further reference to FIG. 4, sensors other than the types shown (temperature, pressure, and gas) may be employed to gather information associated with operation of the beverage dispense system 100 including, for example, flow meters, such as the flow meters 307 shown on the beverage lines 108 for detecting the presence, type and/or volume of fluids (e.g. beverage(s), water, chemical solution(s)) that pass through the lines 108. In accordance with this embodiment, the flow meters 307 are operable to detect whether a certain fluid in a beverage line 108 is a chemical solution or beverage (via pH or conductivity analyses) as well as the volumetric rate of flow of such fluids. Separate pH meters and/or conductivity meters (both of which are not shown for simplicity purposes) may additionally or alternatively be employed. Flow meters 307 may also be located inside the dispensing units 102 for providing information verifying the dispensing of fluids from the units 102 (e.g. proof of delivery), as shown using dashed lines in FIG. 4. As with the temperature sensors 302, the pressure sensors 304, and the gas level sensors 306 described above, the flow meters 307 provide any measured information to the controller 152 by way of data communications lines (e.g. 305), again, which are not shown in FIG. 4 to reduce clutter.

In an exemplary embodiment, the temperature sensor 302 is a Temperature Data Logger (Mfg. No. “Center 340”) manufactured by Center Technology Corp., the pressure sensor 304 is a Pressure Vacuum Gauge (Mfg. No. “3165”) manufactured by Control Company and the gas level sensor 306 is a carbon dioxide detector (Mfg. No. “7001”) manufactured by Telaire. Of course, these specific makes and models of sensors are only illustrative of the type of sensors that may be used to implement the monitoring system 300 of the present invention. Indeed, the present invention is not limited to any particular make and model of temperature sensors 302, pressure sensors 304 or gas level sensors 306.

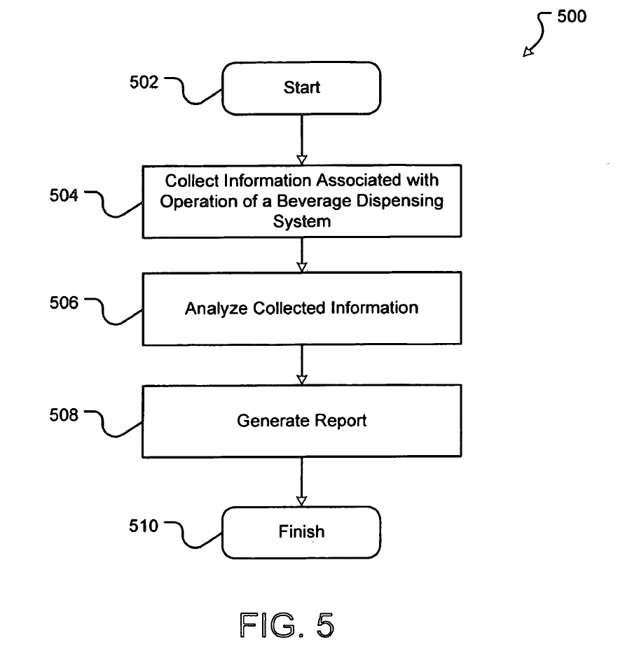

Turning back to FIG. 3, the controller 152 receives signals/information sensed by the temperature sensors 302, the pressure sensors 304, the gas level sensors 306, the flow meters 307 (if utilized) and any other sensors and stores this information to memory 153. The memory 153 is shown as internal to the controller 152 and embodies any form of solid state, non-volatile memory known to those skilled in the art such as, for example, Random Access Memory (RAM), Read-Only Memory (ROM), Erasable Programmable ROM (EPROM), Electrically-Erasable Programmable ROM (EEPROM), Flash Memory and Programmable ROM, etc. Alternatively, the memory 153 may take the form of storage medium readable by an external peripheral device such as, for example, a hard disk, a CD-ROM, a DVD, a storage tape, etc. Regardless of the memory implementation, the controller 152 is operable to access the data/information stored on the memory 153 and analyze the data to render conclusions regarding operation of the beverage dispensing system 100 with respect to at least temperature, pressure, gas detection, and flow characteristics. In an embodiment, the controller 152 evaluates any such rendered conclusions to characterize operation of the beverage dispensing system 100 including, for example, rendering reports/notifications that include a compilation of a portion or all of the sensed information and that identify whether or not the system 100, and in particular a specific component, is malfunctioning. Exemplary analyses are described in greater detail in connection with FIGS. 5-9 in accordance with embodiments of the present invention.

The monitoring system 300 is shown to include parts of the control system 128 in addition to the controller 152 in accordance with an embodiment of the present invention. For example, the monitoring system 300 also includes the GUI 158 and the IR (or, for example, RF) port 129. The GUI 158 and the IR port 129 provide users with access to data/information captured by the sensors 302, 304, 306 and 307 (if utilized) as well as any analyses performed by the controller 152 thereon. As such, user interaction is provided by, for example, touch screen interface (on GUI 158) or by way of a desktop computer, mobile computer such as a laptop, PDA or other handheld computing device (via IR port 129). Using the GUI 158 and/or, for example, a mobile computer interacting through the IR port (129), a user is provided with functionality for monitoring operation of the beverage dispensing system 100 as well as to view reports prepared using the sensed information.

In addition to the local user interaction provided by the GUI 158 and the IR port 129, the monitoring system 300 also provides users with the capability to monitor operation of the beverage dispensing system 100 from remote locations. To accomplish this, the monitoring system 300 includes a remote, or “server,” computer 310 (either fixed or mobile) communicatively connected to the controller 152 by way of a communications network 308. The server computer 310 communicates with the controller 152 to retrieve data stored on the memory 153 (or can retrieve data directly from the controller 152, i.e. without first storing the data to memory 153), which may include any information sensed from the temperature sensors 302, the pressure sensors 304, the gas level sensors 306, the flow meters 307 (if utilized) and any other sensors and/or information embodying analyses (e.g. reports) of such data performed by the controller 152. Once retrieved, the information is stored on a database 312 for future access by user(s). In this regard, the server computer 310 functions as a user interaction mechanism much like the GUI 158 and the IR port 129, but from a remote location relative to the actual location of the beverage dispensing system 100.

The controller 152 connects to the communications network 308 by way of a communication device 309. The communication device 309 may be, for example, a modem, a network interface card (NIC) alone or in combination with a router, hub or Ethernet port, a wireless transmitter, a direct wired connection, etc. In an embodiment of the present invention, the communication device 309 periodically accesses the server computer 310 to provide data, e.g., raw sensed data/information (e.g. temperature readings, pressure readings, gas level readings and/or flow readings) or reports characterizing monitoring operations, for storage in the database 312. As such, the communication device 309 may access real-time data received by the controller 152 and any historical data stored on the local memory 153 for transfer to the database 312. In an alternative embodiment, the communication device 309 maintains communications with the server computer 310 over the communications network 308 continually; therefore, the local memory 153 is preferably unnecessary for storing sensed data. Instead, the communication device 309 continually transmits real-time sensed data to the server computer 310. Optionally, the communication device 309 initiates communications with the server computer 310 over the communications network 308 only when “trouble” within the beverage dispensing system 100 is sensed/determined as described further below.

In addition to data retrieval services, the server computer 310 is also operable to perform analyses on information retrieved from the controller 152 and prepare reports characterizing these analyses in similar fashion to the functionality described for the controller 152 above. That is, the server computer 310 retrieves raw sensed data (e.g. temperature readings, pressure readings, gas level readings and/or flow readings, etc.) stored (or not stored) on the memory 153 and analyzes the retrieved information to render conclusions regarding operation of the beverage dispensing system 100 with respect to at least temperature, pressure, gas detection and flow characteristics. These conclusions are preferably placed into report format and preferably stored on the database 312 for future access by users.

The controller 152 can also or alternatively receive commands from the server computer 310 via the communications network 308 to provide a feedback loop to control system 128. These commands may be used to control processes and operations of the beverage dispensing system 100. Such commands may include calibration commands, cleaning initiation commands, test commands, alarm commands, interactive communications between the system (100) operator or service technician and the server computer (310), and other remote control commands. This capability facilitates the management of multiple, geographically dispersed beverage dispense systems 100 by allowing an operator or the service technician to distribute control commands from a central location via the communications network 308. The commands, including the cleaning initiation commands, may be manually initiated from the server computer 310 (and/or client computer 314 mentioned below) or may be programmed to occur automatically.

A client computer 314, e.g., a thick or thin client, is connected to the server computer 310 by way of a wired or wireless communication link 315 or, alternatively, the communications network 308, as shown in dashed lines. The client computer 314 communicates with the server computer 310 to retrieve data from the database 312 for presentation to a user. As such, the client computer 314 receives reports stored in the database 312 and provides these reports to a user. Alternatively, the client computer 314 may include an analysis application operable to receive raw sensed data (e.g. temperature readings, pressure readings, gas level readings and/or flow readings) stored in the database 312 and analyze this data to generate reports, as described above with reference to the controller 152 and the server computer 310.

Turning now to FIG. 5, a process 500 for monitoring (“monitoring process”) operation of a beverage dispensing system is shown in accordance with an embodiment of the present invention. In particular, the monitoring process 500 embodies a sequence of computer-implemented operations performed to monitor operation of the beverage dispensing system 100, as described in connection with FIGS. 1-4 above. Accordingly, as described in FIGS. 3-4, the monitoring process 500 may be performed by the controller 152, the server computer 310 or the client computer 314, or a combination of any of these three computing modules, in accordance with embodiments of the present invention. While an exemplary system 300 for administering the monitoring process 500 is shown in FIGS. 3-4, along with exemplary sensor types (e.g. temperature sensors 302, pressure sensors 304, gas level sensors 306 and flow meters 307) and monitoring points, it should be appreciated that other systems 300 (with other types and additional or alternative monitoring points) may be employed to administer the monitoring process 500.

The monitoring process 500 is performed using an operation flow that begins with a start operation 502 and concludes with a terminate operation 510. The start operation 502 is initiated as the beverage dispensing system 100 is deployed in its operational environment. From the start operation 502, the operation flow passes to a collect operation 504.

The collect operation 504 collects information associated with operation of the beverage dispensing system 100. In an embodiment, this collected information includes temperature readings, pressure readings and gas level readings associated with various components of the beverage dispensing system 100. For example, an exemplary temperature reading may relate to the temperature of a beverage that flows through a beverage line 108, an exemplary pressure reading may relate to a pressure reading of a pressure exerted within a gas line 148 used to carry a control gas to a coupler 110 and an exemplary gas level reading may relate to the level of carbon dioxide inside the walk-in cooler 162 (e.g. discharged from the one or more secondary regulators 126). In an embodiment, each of the readings/information include a parameter or value (e.g. temperature, pressure or gas level) representing the measurement taken by a sensor (e.g. temperature sensor 302, pressure sensor 304 or gas level sensor 306, respectively), an identifier representing the particular monitoring point from which the measurement was taken (i.e. the location of the sensor) and preferably a time reference indicative of when the measurement was taken. The time reference includes a clock time, a calendar date or both and the monitoring point identifier may be any predetermined identification scheme that uniquely identifies the monitoring points in the beverage dispensing system 100 from one another. In Table 1 in U.S. Patent Application Publication US 2006/0113322, a conventional scheme including exemplary information collected from a plurality of temperature sensors 302 by the collection operation 504 is illustrated.

Returning back to the monitoring process 500, the collection operation 504 may also collect information regarding the flow of fluids within the beverage lines 108 such as, for example, the type of fluids and the volumetric rate of flow of the fluids therethrough. Even further, the collected information may relate to times and dates on which particular phases of the cleaning process are administered. The collection of any of the forms of the above-described information is preferably continuous so long as the beverage dispensing system 100 is operational in its intended environment and therefore, at some predetermined time (e.g. every X number of minutes, days, hours, etc.), the operation flow of the monitoring process 500 passes to the analysis operation 506.

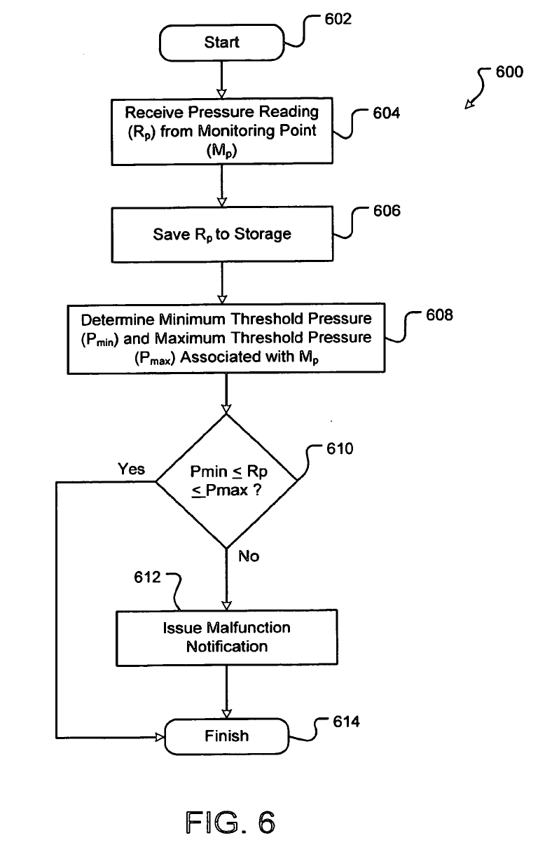

The analysis operation 506 analyzes all or a portion of the information collected by the collection operation 504 to render conclusions regarding operation of the beverage dispensing system 100. For example, the temperature readings, pressure readings and/or gas level readings collected by the collection operation 504 are analyzed against threshold readings to determine whether the beverage dispensing system 100 is malfunctioning. Exemplary analyses are described in greater detail in connection with FIGS. 6-9. From the analysis operation 506, the operation flow passes to a generate report operation 508.

The report operation 508 generates a report characterizing information collected by the collection operation 504. In an embodiment, the report operation 508 generates a report that includes at least some of the information collected by the collection operation 504. For example, the report may include sensed temperature, pressure and/or gas level readings along with the time references corresponding to when such readings were taken. In another embodiment, the report operation 508 generates a report that includes conclusions made based on the analysis operation 506. For example, the report may also include information regarding the number of times (and/or calendar date clock times) that one or more specific phases of the cleaning process have been administered during a given period in time. The report may also characterize the collected information such as, for example, the average, low and/or high readings reflective of measured temperatures, pressures and gas level readings over a given period in time.

Additionally, the report may embody or generate an alarm that is either issued to users through the GUI 158, server computer 310, and/or client computer 314 notifying them that the beverage dispensing system 100 is malfunctioning in some manner. As an example, the report may notify a user that the gas (e.g. carbon dioxide) level in the walk-in cooler 162 is above an appropriate threshold for human consumption. As another example, the report may notify a user that the temperature of beverages being dispensed through the dispensing units 102 is above or below a specified threshold temperature. Exemplary analyses and resulting reports (e.g. alarms and periodic monitoring analyses) are described in further detail with reference to FIGS. 6-9. From the generate report operation 508, the operation flow concludes at the terminate operation 510.

Referring now to FIG. 6, the monitoring process 500 is illustrated in more detail in accordance with an exemplary embodiment of the present invention. More specifically, FIG. 6 illustrates a monitoring process 600 that embodies operational characteristics for monitoring pressures associated with the beverage dispensing system 100 to render a conclusion regarding operation of the beverage dispensing system 100 relative to desired or threshold operating pressures for the system 100. Accordingly, this monitoring process 600 is referred to herein as a “pressure monitoring process.”

The pressure monitoring process 600 is performed using an operation flow that begins with a start operation 602 and concludes with a terminate operation 614. The start operation 602 is initiated after the beverage dispensing system 100 is deployed in its operational environment in response to a pressure sensor 304 sensing a pressure at a pressure monitoring point on the beverage dispensing system 100. As noted above, a pressure monitoring point is a specified location within the system 100 at which a pressure sensor 304 is placed to gather pressure readings. Exemplary pressure monitoring points are depicted in FIG. 4 and described above in connection therewith.

From the start operation 602, the operation flow passes to a collect operation 604. The collect operation 604 receives the sensed pressure reading taken at the pressure monitoring point and the operation flow passes to a storage operation 606. The storage operation 606 saves the sensed pressure reading to memory, such as to the local memory 153 or the database 312, depending on whether the controller 152 or, alternatively, the remote computer 310, respectively, is the computing module responsible for evaluating the sensed pressure reading in furtherance of the pressure monitoring process 600. From the storage operation 606, the operation flow passes to a determination operation 608.

The determination operation 608 determines maximum and minimum threshold pressure values associated with the pressure monitoring point. In an embodiment, the maximum and minimum threshold pressure values are user-defined (predetermined) thresholds pre-loaded on the controller 152 or, alternatively, remote computer 310, and saved for future reference in memory (e.g., on the local memory 153 or the database 312, respectively). In this embodiment, the maximum and minimum threshold pressure values are stored in memory in association with identification of the pressure monitoring point for facilitated reference by either the local controller 152 or the remote server 310. After these threshold parameters are determined, the operation flow passes to a query operation 610.

The query operation 610 analyzes the measured pressure value embodied in the received pressure reading against the maximum and minimum threshold pressure values to determine whether the measured pressure value is found therebetween. If so, the measured pressure reading for that pressure monitoring point conforms to user specifications and the operation flow concludes at the terminate operation 614. Otherwise, the operation flow passes to a report (e.g. notification) operation 612.

The report operation 612 reports the measured pressure value as not conforming to user specification so that a user or other field service provider (e.g. cleaning technician) responsible for servicing the beverage dispensing system 100 may take action to rectify such non-conformance. In an embodiment, the report operation 612 involves issuing an alarm or other alert to the responsible user or other field service provider. Such alarms or alerts may be transmitted to the responsible user/provider through the GUI 158 or IR port 129 or by fax, email, phone, pager, etc. The alarms and alerts indicate that at least one component of the beverage dispensing system 100 is malfunctioning thereby resulting in a non-conforming pressure at the pressure monitoring point being evaluated.

In another embodiment, the report operation 612 additionally or alternatively involves preparing a report and indicating on the report that the beverage dispensing system 100 is malfunctioning while, on this same report, specifically identifying the malfunctioning component. In this embodiment, the prepared report is then saved to memory (e.g., on the local memory 153 or, alternatively, the database 312) for future display to the responsible user or field service provider (in contrast to an immediate alarm or alert). As noted above, if the report and sensed data is stored on the local memory 153, this information may be uploaded via the communication network 308 to the remote computer 310 for further analysis or reporting to users. From the report operation 612, the operation flow concludes at the terminate operation 614.

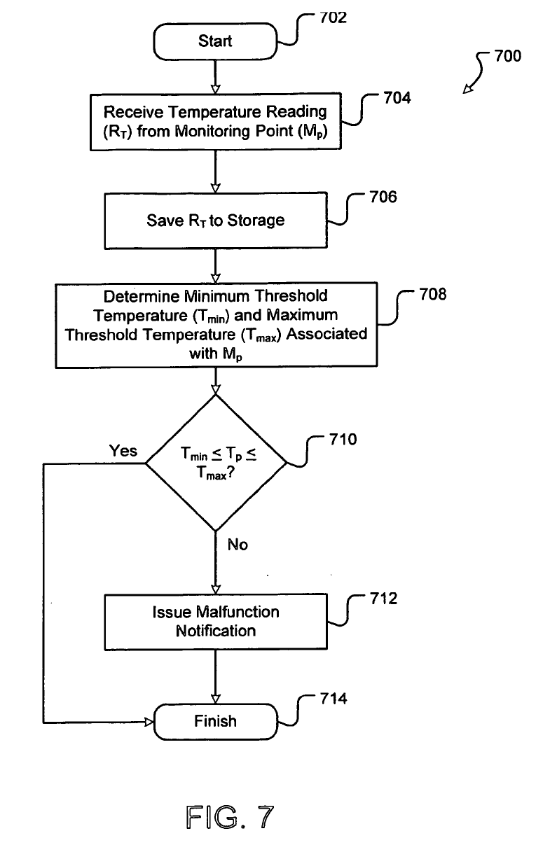

Referring now to FIG. 7, the monitoring process 500 is illustrated in more detail in accordance with another exemplary embodiment of the present invention. More specifically, FIG. 7 illustrates a monitoring process 700 that embodies operational characteristics for monitoring temperatures associated with the beverage dispensing system 100 to render a conclusion regarding operation of the beverage dispensing system 100 relative to desired or threshold operating temperatures for the beverage dispensing system 100. Accordingly, this monitoring process 700 is referred to herein as a “temperature monitoring process.”

The temperature monitoring process 700 is performed using an operation flow that begins with a start operation 702 and concludes with a terminate operation 714. The start operation 702 is initiated after the beverage dispensing system 100 is deployed in its operational environment in response to a temperature sensor 302 sensing a temperature at a temperature monitoring point on the beverage dispensing system 100. As noted above, a temperature monitoring point is a specified location within the beverage dispensing system 100 at which a temperature sensor 302 is placed to gather temperature readings. Exemplary temperature monitoring points are depicted in FIG. 4 and described above.

From the start operation 702, the operation flow passes to a collect operation 704. The collect operation 704 receives the sensed temperature reading taken at the temperature monitoring point and the operation flow passes to a storage operation 706. The storage operation 706 saves the sensed temperature reading to memory, such as to the local memory 153 or the database 312, depending on whether the controller 152 or, alternatively, the remote computer 310, respectively, is responsible for evaluating the sensed temperature reading in furtherance of this temperature monitoring process 700. From the storage operation 706, the operation flow passes to a determination operation 708.

The determination operation 708 determines maximum and minimum threshold temperature values associated with the temperature monitoring point. In an embodiment, the maximum and minimum threshold temperature values are user-defined (predetermined) thresholds pre-loaded on the controller 152 or, alternatively, remote computer 310, and saved for future reference in memory (e.g., on the local memory 153 or the database 312, respectively). In this embodiment, the maximum and minimum threshold temperature values are stored in memory in association with identification of the temperature monitoring point for facilitated reference by either the local controller 152 or the remote server 310. After these threshold parameters are determined, the operation flow passes to a query operation 710.

The query operation 710 analyzes the measured temperature value embodied in the received temperature reading against the maximum and minimum threshold temperature values to determine whether the measured temperature value is found therebetween. If so, the measured temperature value for that temperature monitoring point conforms to user specifications and the operation flow concludes at the terminate operation 714. Otherwise, the operation flow passes to a report (e.g. notification) operation 712.

The report operation 712 reports the measured temperature value as not conforming to user specification so that a user or other field service provider responsible for servicing the beverage dispensing system 100 may take action to rectify such non-conformance. In an embodiment, the report operation 712 involves issuing an alarm or other alert to the responsible user or other field service provider. Such alarms or alerts may be transmitted to the responsible user/provider through the GUI 158 or IR port 129 or by fax, email, phone, pager, etc. The alarms and alerts indicate that at least one component of the beverage dispensing system 100 is malfunctioning thereby resulting in a non-conforming temperature at the temperature monitoring point being evaluated.

In another embodiment, the report operation 712 additionally or alternatively involves preparing a report and indicating on the report that the beverage dispensing system 100 is malfunctioning while, on this same report, specifically identifying the malfunctioning component. In this embodiment, the prepared report is then saved to memory (e.g., on the local memory 153 or, alternatively, the database 312) for future display to the responsible user or field service provider (in contrast to an immediate alarm or alert). In this embodiment, the generated report may be the same report prepared with reference to the pressure monitoring process 600 and, as such, the report operation 712 may involve preparing a report that indicates that the beverage dispensing system 100 is malfunctioning with respect to both a pressure and a temperature. As noted above, if the report and sensed data is stored on the local memory 153, this information may be uploaded via the communication network 308 to the remote computer 310 for further analysis or reporting to users. From the report operation 712, the operation flow concludes at the terminate operation 714.

Turning now to FIG. 8, the monitoring process 500 is illustrated in more detail in accordance with yet another exemplary embodiment of the present invention. More specifically, FIG. 8 illustrates a monitoring process 800 that embodies operational characteristics for monitoring gases released by the beverage dispensing system 100 to provide a warning to users and field service providers regarding unacceptable or unsafe gas levels. For illustration purposes only, the gas is described with reference to FIG. 8 as being, for example, carbon dioxide (“CO₂”), and thus, this monitoring process 800 is referred to herein as a “CO₂ monitoring process.” It should be appreciated that this monitoring process 800 may be employed to monitor gases other than CO₂ and that such monitoring is of course contemplated to be within the scope of the present invention.

The CO₂ monitoring process 800 is performed using an operation flow that begins with a start operation 802 and concludes with a terminate operation 814. The start operation 802 is initiated after the beverage dispensing system 100 is deployed in its operational environment in response to a gas level sensor 306 sensing CO₂ at a gas monitoring point on the beverage dispensing system 100. As noted above, a gas monitoring point is a specified location within the system 100 at which a gas level sensor 306 is placed to gather gas level readings. An exemplary gas monitoring point is depicted in FIG. 4 and described above as being located within the walk-in cooler 162.

From the start operation 802, the operation flow passes to a collect operation 804. The collect operation 804 receives the sensed CO₂ reading taken at the gas monitoring point and the operation flow passes to a storage operation 806. The storage operation 806 saves the sensed CO₂ reading to memory, such as to the local memory 153 or the database 312, depending on whether the controller 152 or, alternatively, the remote computer 310, respectively, is responsible for evaluating the sensed CO₂ reading in furtherance of the CO₂ monitoring process 800. From the storage operation 806, the operation flow passes to a determination operation 808.

The determination operation 808 determines a maximum threshold CO₂ value associated with the gas monitoring point. In an embodiment, the maximum threshold CO₂ value is a user-defined (predetermined) threshold pre-loaded on the controller 152 or, alternatively, remote computer 310, and saved for future reference in memory (e.g., on the local memory 153 or the database 312, respectively). The maximum threshold CO₂ value therefore represents a maximum level of CO₂ that may be discharged within an enclosed area (e.g., walk-in cooler 162) keeping in mind the safety of any humans enclosed therein or in the vicinity thereof. In this embodiment, the maximum threshold CO₂ value is stored in memory in association with identification of the gas monitoring point for facilitated reference by either the local controller 152 or the remote server 310. After the maximum threshold CO₂ value is determined, the operation flow passes to a query operation 810.

The query operation 810 analyzes the measured CO₂ value embodied in the received CO₂ reading against the maximum threshold CO₂ value to determine whether the measured CO₂ value is less than the maximum threshold CO₂ value. If so, the measured CO₂ value for that gas monitoring point conforms to safety specifications for human interaction and the operation flow concludes at the terminate operation 814. Otherwise, the operation flow passes to a report (e.g. notification) operation 812.

The report operation 812 reports the measured CO₂ value as not conforming to user specification so that a user or other field service provider responsible for servicing the beverage dispensing system 100 may take action to rectify such non-conformance. In an embodiment, the report operation 812 involves issuing an alarm or other alert to the responsible user or other field service provider. Such alarms or alerts may be transmitted to the responsible user/provider through the GUI 158 or IR port 129 or by fax, email, phone, pager, etc. The alarms and alerts indicate that the detected CO₂ level is not safe for human contact and, therefore, that the beverage dispensing system 100 is malfunctioning. In another embodiment, the report operation 812 additionally or alternatively involves preparing a report and indicating that the beverage dispensing system 100 is malfunctioning while, on this same report, specifically identifying the gas monitoring point from which the unsafe CO₂ level was measured. However, due to the harmful effects resulting from exposure to unsafe CO₂ levels, the report operation 812 preferably immediately issues an alarm as described above either with or without also preparing a report (similarly to the temperature and pressure monitoring processes described above) for future use. In yet another embodiment, the report operation 812 may involve activating fan(s) or ventilation system (not shown) within the enclosed area (e.g. walk-in cooler 162) being monitored by the gas level sensor 306 that triggered the start operation 802. From the report operation 812, the operation flow concludes at the terminate operation 814. Report operations 612 and/or 712 may optionally issue an alarm as described above either with or without also preparing a report for future use.

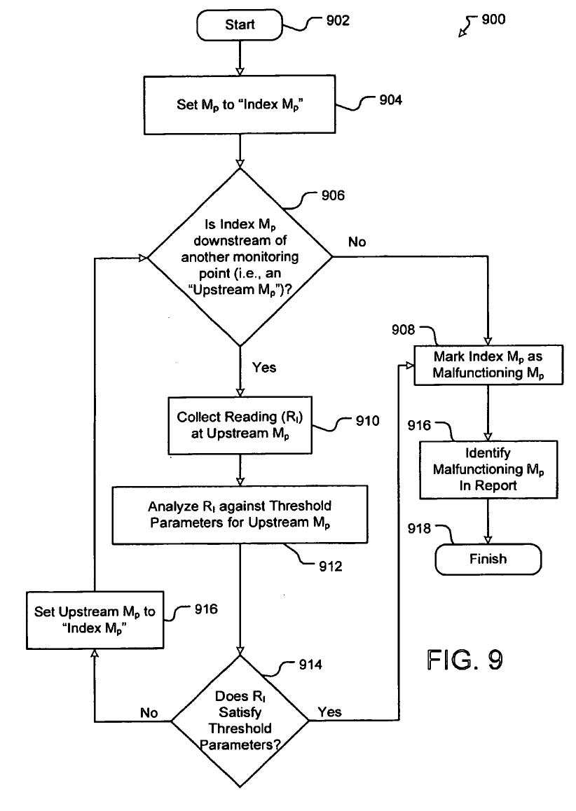

Turning now to FIG. 9, a process 900 for monitoring operation of a beverage dispensing system is shown in accordance with yet another embodiment of the present invention. This process 900 embodies operational characteristics for analyzing a malfunction in the beverage dispensing system 100, as identified based on any of the processes 500, 600, 700 and 800 described above in FIGS. 5-8. More specifically, the process 900 of FIG. 9 relates to a troubleshooting procedure in which the beverage dispensing system 100 is analyzed to determine the origin of a malfunction detected based on any of the analyses described above in connection with FIGS. 5-8. Accordingly, the process 900 is hereinafter referred to as a “troubleshooting process” for nomenclature purposes.

The troubleshooting process 900 is performed using an operational flow that begins with a start operation 902 and concludes with a terminate operation 918. The start operation 902 is initiated in response to detection that a measured value embodied in a sensed reading (e.g. temperature, pressure, gas level, flow characteristics, etc.) from a monitoring point does not conform with user specifications. In this regard, the start operation 902 is initiated in response to the analysis operation 506 or any one of the query operations 610, 710 or 810 determining that a measured value of a particular characteristic (e.g., temperature, pressure, gas, flow, etc.) does not satisfy user specifications, e.g., such as a maximum or minimum threshold value, as described above in connection with FIGS. 6-8. From the start operation 902, the operation flow passes to a set index operation 904.

The set index operation 904 labels the monitoring point from which the non-conforming value was measured as an index monitoring point for use in processing through the troubleshooting process 900. After this monitoring point is labeled the index monitoring point, the operation flow passes to a first query operation 906. The first query operation 906 analyzes the beverage dispensing system 100 to determine whether the index monitoring point is downstream from at least one other monitoring point, these other monitoring points being referred to as “upstream” monitoring points. An “upstream” monitoring point is a monitoring point having a sensor that senses information at a location in the beverage dispensing system 100 that measures a characteristic (e.g., temperature, pressure, gas, flow) of a particular substance (e.g., gas, beverage, water, chemical solution, etc.) prior to that same characteristic being measured by another sensor located at a “downstream” monitoring point. As such, the upstream monitoring points are relatively closer to the origin of a substance than the downstream monitoring points.

If the first query operation 906 determines that the index monitoring point is a “downstream” monitoring point relative to at least one other monitoring point, there is a chance, at least, that the non-conformance at the index monitoring point is actually caused by a malfunction at an upstream monitoring point. In this case, the operation flow passes to a collect operation 910, which extends the troubleshooting process 900 to more specifically pinpoint the location of the malfunction within the beverage dispensing system 100. This branch of the operation flow is described in detail below. Conversely, without an upstream monitoring point, the malfunction in the beverage dispensing system 100 occurs at the index monitoring point and the operation flow passes to a mark operation 908, which marks the index monitoring point as being the site of the malfunction. From the mark operation 908, the operational flow passes to an identification operation 916.

In an embodiment, the identification operation 916 embodies operational characteristics of the report operations 508, 612, 712 and 812. In this operation (i.e., 916), the index monitoring point is reported to a responsible user/field service provider to be the site of a malfunction in the beverage dispensing system 100. As noted above, such reporting may involve issuing an alarm/alert indicative of the malfunction or may alternatively (or additionally) include preparing an actual report that preferably indicates the date and time of the malfunction.

Following the “yes” branch from the first query operation 906, the collect operation 910 retrieves a sensed reading taken at the upstream monitoring point of the same characteristic that was found to be non-conforming at the index monitoring point. In an embodiment, the collect operation 910 involves utilizing a sensor, for example, 302, 304, 306 or 307, at the upstream monitoring point to take a real-time reading of this characteristic. In another embodiment, the collect operation 910 involves accessing memory 153 to retrieve the most recent reading of this characteristic from the upstream monitoring point, in which case retrieval is accomplished using the unique identifier of the upstream monitoring point and the time reference. Regardless of the manner in which the reading is collected, though, the operational flow passes to an analysis operation 912 after the sensed reading from the upstream monitoring point is collected.

The analysis operation 912 analyzes the measured value embodied in the sensed reading from the upstream monitoring point against a corresponding maximum and/or minimum threshold value (i.e. the threshold values defined for that monitoring point) to determine whether the measured value conforms to user specifications, as described in connection with FIGS. 5-8. From the analysis operation 912, the operational flow passes to a second query operation 914. The second query operation 914 branches the operational flow of the troubleshooting process 900 to a second set operation 916 if the measured value analyzed by the analysis operation 912 does not conform to user specifications. The second set operation 916 sets the upstream monitoring point to the index monitoring point and the operational flow of the troubleshooting process 900 returns to the first query operation 906 and continues as described above. If, however, the measured value analyzed by the analysis operation 912 conforms to user specifications, then the second query operation 914 branches the operational flow to the mark operation 908 and the troubleshooting process 900 continues as described above.

While exemplary embodiments of the present invention described above relate to monitoring temperatures, pressures, gas levels and flow characteristics, it should be appreciated that the monitoring processes 500, 600, 700 and 800 and the troubleshooting process 900 are applicable to monitor other forms of collected information as well. As such, the monitoring system 300 shown in FIGS. 3 and 4 may contain sensors (e.g. pH, conductivity, etc.) in addition to or as an alternative to the temperature sensors 302, pressure sensors 304, gas level sensors 306 and flow meters 307, wherein these other sensor types sense information and provide the sensed information to the controller 152 for analysis in furtherance of the above-described monitoring processes 500, 600, 700 and 800.

Additionally, the beverage dispensing system 100 is shown in accordance with an exemplary embodiment to include a walk-in cooler 162 for storage of the beverage containers 104 therein at a desired cooled temperature. It should be appreciated that alternative embodiments may involve the beverage dispensing system 100 being implemented without a walk-in cooler 162 such that the beverage containers 104 are stored at a relatively warm temperature. In this embodiment, the beverage dispensing system 100 preferably may include a cooler integrated around the beverage lines 108 in addition or as an alternative to the glycol cooler 160. Alternatively, an equivalent fluid chilling system in order to drive the temperature of the beverages inside the beverage lines 108 to a desired temperature when dispensed through the dispense units 102. Such (and other) conventional cooling techniques may be employed and will be considered within the scope of the present invention. In yet another embodiment, a plurality of threshold CO₂ values may be defined (e.g. predetermined) for a particular gas monitoring point. In such an embodiment, the CO₂ monitoring process 800 may be administered sequentially for the same monitoring point with the determination operation 808 selecting in sequence each of the plurality of threshold CO₂ values to determine where the measured value ranks within the plurality of threshold CO₂ values. For example, the least valued threshold CO₂ value in the plurality may simply indicate a harmful, but not fatal CO₂ concentration, whereas the most valued threshold CO₂ value may represent a fatal CO₂ concentration.

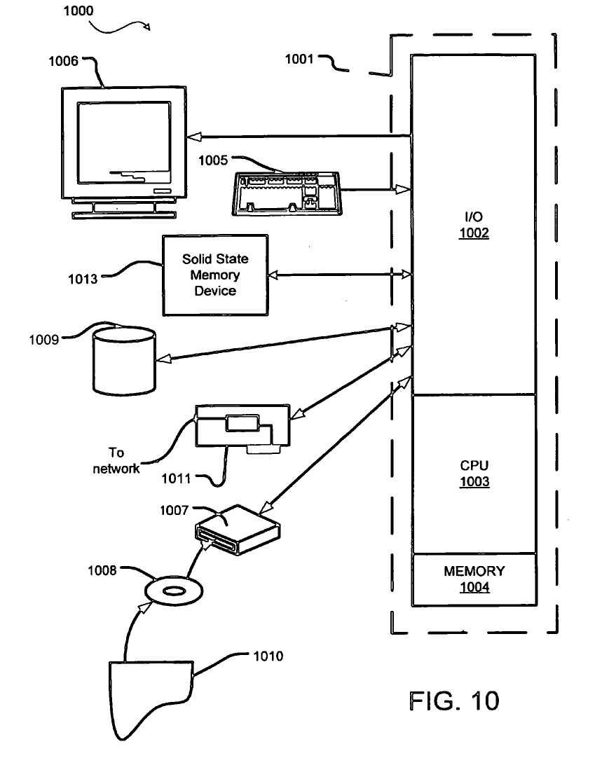

Furthermore, the controller 152, which is described herein as conventional electrical and electronic devices/components, such as, without limitation, programmable logic controllers (PLC's) and logic components, may alternatively be a processor 1001 integrated into a computer readable medium environment as optionally shown in FIG. 10. As such, the logical operations of the present invention described in FIGS. 5-9 may be administered by the processor 1001 in this computer readable medium environment. Referring to FIG. 10, such an embodiment is shown by a computing system 1000 capable of executing a computer readable medium embodiment of the present invention.

One operating environment in which the present invention is potentially useful encompasses the computing system 1000, such as, for example, control system 128 or a remote computer (e.g. 310) to which information collected by the control system 128 may be uploaded. In such a system, data and program files may be input to the computing system 1000, which reads the files and executes the programs therein. Some of the elements of a computing system 1000 are shown in FIG. 10 wherein the processor 1001 includes an input/output (I/O) section 1002, a microprocessor, or Central Processing Unit (CPU) 1003, and a memory section 1004. The present invention may be optionally implemented in this embodiment in software or firmware modules loaded in memory 1004 and/or stored on a solid state, non-volatile memory device 1013, a configured CD-ROM 1008 or a disk storage unit 1009. As such, the computing system 1000 is used as a “special-purpose” machine for implementing the present invention.

The I/O section 1002 is connected to a user input module 1005, e.g., a keyboard, a display unit 1006, etc., and one or more program storage devices, such as, without limitation, the solid state, non-volatile memory device 1013, the disk storage unit 1009, and the disk drive unit 1007. The solid state, non-volatile memory device 1013 is an embedded memory device for storing instructions and commands in a form readable by the CPU 1003. In accordance with various embodiments, the solid state, non-volatile memory device 1013 may be Read-Only Memory (ROM), an Erasable Programmable ROM (EPROM), Electrically-Erasable Programmable ROM (EEPROM), a Flash Memory or a Programmable ROM, or any other form of solid state, non-volatile memory. In accordance with this embodiment, the disk drive unit 1007 may be a CD-ROM driver unit capable of reading the CD-ROM medium 1008, which typically contains programs 1010 and data. Alternatively, the disk drive unit 1007 may be replaced or supplemented by a floppy drive unit, a tape drive unit, or other storage medium drive unit. Computer readable media containing mechanisms (e.g. instructions, modules) to effectuate the systems and methods in accordance with the present invention may reside in the memory section 1004, the solid state, non-volatile memory device 1013, the disk storage unit 1009 or the CD-ROM medium 1008. Further, the computer readable media may be embodied in electrical signals representing data bits causing a transformation or reduction of the electrical signal representation, and the maintenance of data bits at memory locations in the memory 1004, the solid state, non-volatile memory device 1013, the configured CD-ROM 1008 or the storage unit 1009 to thereby reconfigure or otherwise alter the operation of the computing system 1000, as well as other processing signals. The memory locations where data bits are maintained are physical locations that have particular electrical, magnetic, or optical properties corresponding to the data bits.

In accordance with a computer readable medium embodiment of the present invention, software instructions stored on the solid state, non-volatile memory device 1013, the disk storage unit 1009, or the CD-ROM 1008 are executed by the CPU 1003. In this embodiment, these instructions may be directed toward administering application of a cleaning process, customized or non-customized, to a beverage dispensing system. Data used in the analysis of such applications may be stored in memory section 1004, or on the solid state, non-volatile memory device 1013, the disk storage unit 1009, the disk drive unit 1007 or other storage medium unit(s) coupled to the computing system 1000.

In accordance with one embodiment, the computing system 1000 further comprises an operating system and usually one or more application programs. Such an embodiment is familiar to those of ordinary skill in the art. The operating system comprises a set of programs that control operations of the computing system 1000 and allocation of resources. The set of programs, inclusive of certain utility programs, also provide a graphical user interface to the user. An application program is software that runs on top of the operating system software and uses computer resources made available through the operating system to perform application specific tasks desired by the user. The operating system is operable to multitask, i.e., execute computing tasks in multiple threads, and thus may be, for example, any of the following: any of Microsoft Corporation's “WINDOWS” operating systems, IBM's OS/2 WARP, Apple's MACINTOSH OSX operating system, Linux, UNIX, etc.

In accordance with yet another embodiment, the processor 1001 connects to the communications network 308 by way of, for example, a network interface, such as, for example, the network adapter 1011 shown in FIG. 10 or any conventional wired or wireless network connection. Through this network connection, the processor 1001 is operable to transmit information to the remote computer 310 (and/or client computer 314), as described in connection with the controller 152 shown in FIG. 3. Various types of information may be transmitted from the processor 1001 to the remote computer 310 or client computer 314 over the network connection. In addition, the network adaptor 1011 enables users at the remote computer 310 or the client computer 314 the ability to issue commands to the processor 1001 if so desired, also as described above in connection with the controller 152 shown in FIG. 3.

Additionally, while the remote/server computer 310 is shown in FIG. 3 to be communicatively connected to only a single controller 152, it should be appreciated that the server computer 310 may communicate with any number of controllers 152 through the communications network 308. As such, the monitoring system 300 may include only a single controller 152 (as shown for illustrative purposes) or a plurality of controllers 152. Accordingly, the server computer 310 is operable to retrieve data and/or analyses (e.g. reports) from any number of disparately located multiple controllers 152.

The communications network 308 in any of the embodiments described above may include the Internet, World Wide Web (WWW), or any networked environment.

Upon any detected/monitored “malfunction” as described in any of the embodiments above, the in-line cleaning (chemical dispensing) system as described above with reference to FIGS. 1, 2, and 4 (i.e. whether automated or manually initiated) may be utilized to correct (e.g. clean) the entire beverage dispensing system 100 or only the malfunctioning component(s) as identified in any of the above embodiments. Alternatively, a non-automated (i.e. manual) cleaning system involving at least one cleaning technician manually deploying the cleaning ingredients (e.g. water, chemical solutions, etc.) throughout the entire beverage dispensing system or only the malfunctioning component(s) may be utilized within the scope of the present invention. The at least one cleaning technician may employ the manually initiated cleaning process(es) in substitution of all or portions (i.e. preferably only the malfunctioning component(s)) of the in-line cleaning system (e.g. gas-fluid junctions 132, multiplier 130, etc.) shown in FIGS. 1, 2, and 4. For example, the manually initiated cleaning system may be employed at manual cleaning location 199 as shown schematically (in phantom) in FIGS. 1 and 4. In this exemplary embodiment, the entire cleaning system shown towards the left side of the manual cleaning location 199 shown in FIGS. 1 and 4 may be eliminated. In situations where the chemical control system 128 is eliminated, any of its function(s) (e.g. retrieval of sensed readings/information from the sensors, analyses of the sensed readings/information, rendering of conclusions, evaluation of rendered conclusions, or generation/transmission of reports including indication(s) of malfunction(s) and optionally their location(s) within the beverage dispensing system 100) may alternatively be provided by the remote computer 310 or the client computer 314, or a combination of any of these computing modules (computing devices) as described in any of the embodiments above.

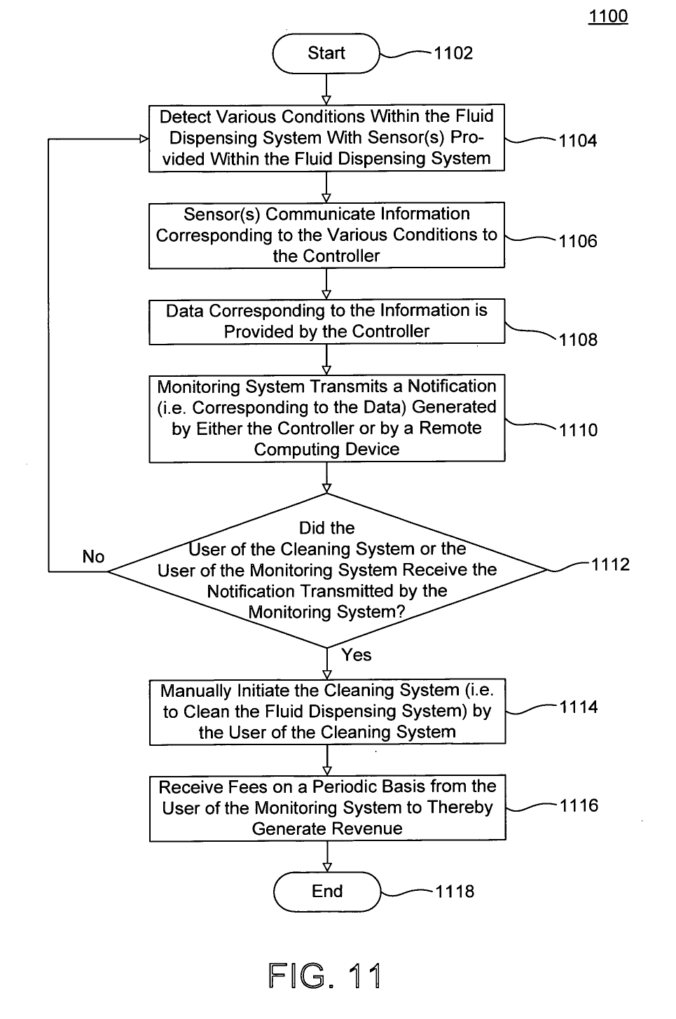

FIG. 11 is a flow chart illustrating operational characteristics of a method of generating revenue 1100 for monitoring of a fluid dispensing system, in accordance with a preferred embodiment of the present invention. Method 1100 is performed using an operation flow that begins with a start operation 1102 and concludes with a terminate operation 1118. The start operation 1102 is initiated as the fluid dispensing system (e.g. beverage dispensing system 100) is deployed in its operational environment. The method comprises the step of providing a fluid dispensing system. The method also comprises the step of providing a monitoring system. The step of providing a monitoring system comprises providing a controller (e.g. 152), and providing at least one sensor (e.g. 302, 304, 306, 307, etc.) within the fluid dispensing system. Various conditions within the fluid dispensing system are detected with the at least one sensor (step 1104). The at least one sensor communicates information (e.g. measured readings) corresponding to the various conditions to the controller (step 1106). Data corresponding to the information is provided by the controller (step 1108). The information received by the controller and the data provided by the controller may be the same. In this scenario, the processing (e.g. any one or more of analyses of the sensed readings/information, rendering of conclusions, evaluation of rendered conclusions, or generation/transmission of reports including indication(s) of malfunction(s) and optionally their location(s) within the beverage dispensing system 100) of the information may preferably occur using a remote computer 310 or client computer 314 via transmission of the information using communications network 308 as described in any of the embodiments above. Of course, the controller 152 may alternatively or additionally process the information to thereby form the data.

The monitoring system transmits (via, for example, the controller or a remote computing device (e.g. remote computer 310 or client computer 314)) a notification (i.e. report) generated by either the controller or by the remote computing device (step 1110). The remote computing device is communicatively connected to the controller via communications network 308. The notification corresponds to the data. The notification/reporting preferably may involve issuing an alarm and/or alert indicative of the malfunction or may alternatively (or additionally) include preparing an actual report that preferably indicates the date, time, and location of the malfunction within the fluid dispensing system. Alternatively, logging/storing of the data (i.e. in the form of either the raw information or processed information which forms the data) may be utilized for subsequent retrieval and/or subsequent processing (including, for example, subsequent generation/transmission of a notification) using, for example, memory 153 and/or database 312. In any of the above embodiments (e.g. even when a memory or a database are employed), the monitoring may optionally be performed real-time if desired. These real-time or subsequent notification retrieval techniques may be employed as described in any of the above embodiments.

The method further comprises the step of providing a manually initiated cleaning system that cleans the fluid dispensing system. The cleaning system is manually initiated by a user of the cleaning system (e.g. cleaning technician) (step 1114) in response to either the user of the cleaning system or a user of the monitoring system receiving the notification transmitted by the monitoring system (step 1112). The method yet further comprises the step of receiving fees on a periodic basis from the user of the monitoring system (step 1116), wherein the received fees generate revenue. Alternatively, instead of steps 1112 and 1114, the step of providing a manually initiated cleaning system may be replaced with a step of providing an automated cleaning system that cleans the fluid dispensing system, wherein the automated cleaning system is initiated in response to the notification transmitted by the monitoring system. Step 1116 would subsequently follow similarly as described above.

Process 1100 may utilize any of the monitoring techniques (e.g. including those for retrieval of sensed readings/information from the sensors, analyses of the sensed readings/information, rendering of conclusions, evaluation of rendered conclusions, or generation/transmission of reports including indication(s) of malfunction(s) and optionally their location(s) within the beverage dispensing system 100) as described in any of the above embodiments, or may utilize other conventional techniques known to those skilled in the art.

In accordance with a preferred embodiment of the present invention, the method is preferably further defined as having an amount of the received fees being determined based on the data. In another preferred embodiment, the amount of the received fees varies based on fluctuations in the data from one period to a subsequent period. Storage/logging of prior periodical data may be stored/logged in a memory or a database (i.e. using techniques as described above) for subsequent comparison with current periodical data. This scenario would result in a variation of the received fees being dependent on the cleanliness of the fluid dispensing system. Dirtier components found within the fluid dispensing system would result in a generation of relatively higher received fees. Likewise, cleaner lines would result in a generation of relatively lower received fees. Similarly, in another preferred embodiment, an amount of the received fees may be determined based on a comparison of the data using historical data (i.e. from any prior period) and current data. In another preferred embodiment, the amount of the received fees may vary based on the comparison from one period to a subsequent period. In these embodiments, any of the storage/logging techniques described above may be utilized within the scope of the present invention.

In any of the above embodiments, the user of the monitoring system or the user of the cleaning system may receive the notification transmitted by the monitoring system when the data deviates from an amount or range. The amount or range may be determined based on historical data, may be predetermined, or may be calculated using a ratio which is determined using historical data. The user of the monitoring system and the user of the cleaning system is the same entity or may be different entities. When they are different entities, if the user of the monitoring system receives the notification, then user of the monitoring system will forward the notification (or item representative of the notification) to the user of the cleaning system so that the user of the cleaning system may take action, i.e. clean the malfunctioning system or portion(s) thereof.

In any of the above embodiments, the data comprises or corresponds to an item selected from the group consisting of flow data, temperature data, pressure data, gas data, pH data, and combinations thereof. The data may alternatively or additionally comprise elapsed time data corresponding to elapsed time between adjacent cycles of the cleaning of the fluid dispensing system by the manually initiated cleaning system. Alternatively, the data may comprise elapsed time data corresponding to elapsed time determined from a start of a cycle of the cleaning of the fluid dispensing system by the manually initiated cleaning system to a start of an adjacent subsequent cycle of the cleaning of the fluid dispensing system by the manually initiated cleaning system. Or, the data may comprise elapsed time data corresponding to elapsed time determined from an end of a cycle of the cleaning of the fluid dispensing system by the manually initiated cleaning system to an end of an adjacent subsequent cycle of the cleaning of the fluid dispensing system by the manually initiated cleaning system. Further, in another embodiment, the data may comprise time duration data corresponding to a duration of a cycle of the cleaning of the fluid dispensing system by the manually initiated cleaning system.

In accordance with another preferred embodiment of the present invention, the periodic basis for receiving the fees is determined based on the data. In another preferred embodiment, the periodic basis for receiving the fees varies based on fluctuations in the data from one period to a subsequent period. Storage/logging of prior periodical data may be stored/logged in a memory or a database (i.e. using techniques as described above) for subsequent comparison with current periodical data. This scenario would result in a variation of the periodic basis used for receiving the fees being dependent on the cleanliness of the fluid dispensing system. Dirtier components found within the fluid dispensing system would result in receiving fees on a more frequent basis. Likewise, cleaner lines would result in receiving fees on a less frequent basis. Similarly, in another preferred embodiment, the periodic basis for receiving the fees may be determined based on a comparison of the data using historical data (i.e. from any prior period) and current data. In another preferred embodiment, the periodic basis for receiving the fees varies based on the comparison from one period to a subsequent period. In these embodiments, any of the storage/logging techniques described above may be utilized within the scope of the present invention.

In any of the above embodiments the data leading to the notification being generated may correspond to information received from a single sensor, or alternatively from two or more sensors. In the latter case, a combination of information from multiple sensors (e.g. temperature information and pressure information) may result in a generation of the notification, whereas a information received from only the temperature sensor or only the pressure sensor (i.e. when considered/evaluated alone) might not necessarily trigger the generation of the notification.

The historical data mentioned in any of the embodiments above may be stored/logged in a memory or a database (i.e. using techniques as described above) for subsequent comparison.

As exemplified by FIGS. 5-9, the particular operational characteristics, sequences, and/or programming (i.e. used by, for example, the controller 152, remote computer 310 and/or client computer 314 for retrieval of sensed readings/information from the sensors, analyses of the sensed readings/information, rendering of conclusions, evaluation of rendered conclusions, and/or generation/transmission of reports, etc.) required to accomplish any of the features/functions of the present invention described above (e.g. analyses using comparisons of historical data in storage) will of course fall within the knowledge of the skilled artisan in view of the teachings of the present disclosure.

Providing a monitoring system whose associated generated revenue is dependent on detected various conditions within the fluid dispensing system would establish sufficient and ongoing incentive for customers/users to maintain cleaner lines in order to avoid higher monitoring costs resulting in safer fluid consumption.

Those of ordinary skill in the art will recognize that various modifications and variations may be made to the embodiments described above without departing from the spirit and scope of the present invention. For example, although the embodiments above describe aspects of the invention in conjunction with a beer-type fluid dispensing system, other fluid dispensing systems may alternatively be utilized within the scope of the present invention. As an example, the fluid dispensing system of the present invention may alternatively or additionally dispense other types of beverages such as, for example, liquor, soda, juice, milk, water, caffeine-containing beverage (e.g. coffee), or combinations (including possibly beer) thereof. As another alternative, the fluid dispensing system of the present invention may alternatively or additionally dispense non-beverage-type fluids such as, for example, paint, oil, fuel, gasoline, kerosene, lacquer, varnish, adhesives, primer, etc. It is therefore to be understood that the present invention is not limited to the particular embodiments disclosed above, but it is intended to cover such modifications and variations as defined by the following claims.

What is claimed is:

1. A method of generating revenue for monitoring of a fluid dispensing system, the method comprising:
providing a fluid dispensing system;
providing a monitoring system comprising:
providing a controller;
providing at least one sensor within the fluid dispensing system, wherein various conditions within the fluid dispensing system are detected with the at least one sensor, wherein the at least one sensor communicates information corresponding to the various conditions to the controller, wherein data corresponding to the information is provided by the controller, wherein the monitoring system transmits a notification generated by either the controller or by a remote computing device communicatively connected to the controller via a communications network, and wherein the notification corresponds to the data.
providing a manually initiated cleaning system that cleans the fluid dispensing system, wherein the cleaning system is manually initiated by a user of the cleaning system in response to either the user of the cleaning system or a user of the monitoring system receiving the notification transmitted by the monitoring system;
receiving fees on a periodic basis from the user of the monitoring system, wherein the received fees generate revenue.

2. The method according to claim 1, wherein an amount of the received fees is determined based on the data, and wherein the amount of the received fees varies based on fluctuations in the data from one period to a subsequent period.

3. The method according to claim 1, wherein an amount of the received fees is determined based on a comparison of the data using historical data and current data.

4. The method according to claim 3, wherein the amount of the received fees varies based on the comparison from one period to a subsequent period.

5. The method according to claim 1, wherein the user of the monitoring system or the user of the cleaning system receives the notification transmitted by the monitoring system when the data deviates from an amount or range.

6. The method according to claim 5, wherein the amount or range is determined based on historical data.

7. The method according to claim 5, wherein the amount or range is predetermined.

8. The method according to claim 5, wherein the amount or range is calculated using a ratio which is determined using historical data.

9. The method according to claim 1, wherein the user of the monitoring system and the user of the cleaning system is the same entity.

10. The method according to claim 1, wherein the data comprises or corresponds to an item selected from the group consisting of flow data, temperature data, pressure data, gas data, pH data, and combinations thereof.

11. The method according to claim 1, wherein the data comprises elapsed time data corresponding to elapsed time between adjacent cycles of the cleaning of the fluid dispensing system by the manually initiated cleaning system.

12. The method according to claim 1, wherein the data comprises elapsed time data corresponding to elapsed time determined from a start of a cycle of the cleaning of the fluid dispensing system by the manually initiated cleaning system to a start of an adjacent subsequent cycle of the cleaning of the fluid dispensing system by the manually initiated cleaning system.

13. The method according to claim 1, wherein the data comprises elapsed time data corresponding to elapsed time determined from an end of a cycle of the cleaning of the fluid dispensing system by the manually initiated cleaning system to an end of an adjacent subsequent cycle of the cleaning of the fluid dispensing system by the manually initiated cleaning system.

14. The method according to claim 1, wherein the data comprises time duration data corresponding to a duration of a cycle of the cleaning of the fluid dispensing system by the manually initiated cleaning system.

15. The method according to claim 1, wherein the periodic basis for receiving the fees is determined based on the data, and wherein the periodic basis for receiving the fees varies based on fluctuations in the data from one period to a subsequent period.

16. The method according to claim 1, wherein the periodic basis for receiving the fees is determined based on a comparison of the data using historical data and current data.

17. The method according to claim 16, wherein the periodic basis for receiving the fees varies based on the comparison from one period to a subsequent period.

18. The method according to claim 1, wherein the fluid dispensing system dispenses a beverage selected from the group consisting of beer, liquor, soda, juice, milk, water, coffee, and combinations thereof.

19. The method according to claim 1, wherein the monitoring of the fluid dispensing system occurs in real-time.

20. The method according to claim 1, wherein the controller processes the information to thereby form the data.

21. The method according to claim 1, wherein the information and the data are the same.

22. The method according to claim 1, wherein the data corresponds to information received from two or more sensors.

23. A method of generating revenue for monitoring of a fluid dispensing system, the method comprising:
providing a fluid dispensing system;
providing a monitoring system comprising:
providing a controller;
providing at least one sensor within the fluid dispensing system, wherein various conditions within the fluid dispensing system are detected with the at least one sensor, wherein the at least one sensor communicates information corresponding to the various conditions to the controller, wherein data corresponding to the information is provided by the controller, wherein the monitoring system transmits a notification generated by either the controller or by a remote computing device communicatively connected to the controller via a communications network, and wherein the notification corresponds to the data.
providing an automated cleaning system that cleans the fluid dispensing system, wherein the cleaning system is initiated in response to the notification transmitted by the monitoring system;
receiving fees on a periodic basis from a user of the monitoring system, wherein the received fees generate revenue.

24. The method according to claim 23, wherein an amount of the received fees is determined based on a comparison of the data using historical data and current data, and wherein the amount of the received fees varies based on the comparison from one period to a subsequent period.

25. The method according to claim 23, wherein the periodic basis for receiving the fees is determined based on a comparison of the data using historical data and current data, and wherein the periodic basis for receiving the fees varies based on the comparison from one period to a subsequent period.
